(19) United States
(12) Patent Application Publication
(10) Pub. No.: US 2013/0292103 A1
(43) Pub. Date: Nov. 7, 2013

(54) Apparatus and Method for Connecting Air Cooled Condenser Heat Exchanger Coils to Steam Distribution Manifold

(71) Applicant: Evapco, Inc., Taneytown, MD (US)

(72) Inventor: Jeftha Eindhoven, Somerville, NJ (US)

(21) Appl. No.: 13/864,068

(22) Filed: Apr. 16, 2013

Related U.S. Application Data
(60) Provisional application No. 61/624,763, filed on Apr. 16, 2012.

(51) Int. Cl. F28B 1/06; B23P 15/26

(52) U.S. Cl. CPC F28B 1/06; B23P 15/26
USPC 165/173; 29/890.038

(57) ABSTRACT

An air cooled condenser, and methods of manufacturing and field assembly of air cooled condensers in which one half of the primary heat exchanger coils are shop fitted with a length of steel configured to quickly and easily mate, during field assembly, with an opposing primary heat exchanger coil of standard configuration, thereby reducing material, shipping, and handling costs, improving positioning and orientation of HECs during assembly, and reducing the requirement for expensive field welding.

### FIELD OF THE INVENTION

The present invention relates to air-cooled condensing systems and more particularly to an air cooled condensing system that maintains thermodynamic efficiency but is much simpler and cheaper in physical installation than the current state of the art air cooled condensing systems.

### BACKGROUND OF THE INVENTION

Current state of the art air cooled condensing systems use flat two-dimensional tube sheets. The elevation of tube sheets in an A-framed air cooled condenser (“ACC”) is not constant due to manufacturing tolerances, erection tolerances and deflection of the actual support system and heat exchange cores. Because of this elevation difference, a zero welding gap cannot be maintained with the current two-dimensional flat tube sheets. That is, the two component heat exchange coils of an A-frame ACC cannot be welded directly to one-another.

The typical arrangement of an air cooled condenser according to the current state of the art is shown in FIG. 1. The steam distribution manifold (“SDM”) sits on top of the intersection between two heat exchanger coils (“HECs”). During field assembly, the primary heat exchanger coils are erected into place, and welded indirectly together at their intersection. Once the two heat exchanger coils are welded together, the SDM is placed or assembled on top of the previously joined heat exchanger coils. According to current design and practice, the two primary heat exchanger coils are joined by placing a closure plate between the tube sheets of each heat exchanger coil, and the closure plate is field welded to the tube sheet of both exchanger coils. These welds can run virtually the full length of the Air Cooled Condenser. The current design is shown in detail in FIGS. 2-5. This design and configuration has been in constant use, with little variation, since the advent of ACCs in the 1970s.

FIG. 3 shows where the closure plate is field welded to each of the HEC tube sheets, as well as where each HEC tube sheet is field welded to its corresponding SDM skirt. The SDM is not shown for the purposes of clarity. FIG. 4 is a computer model rendering of an end view of the arrangement shown at the bottom of FIG. 3, and FIG. 5 is a computer model rendering of a close-up underside perspective view of the current (prior art) HEC tube junction configuration, including the location and orientation of the closure plate.

### SUMMARY OF THE INVENTION

The current ACC design requires a significant amount of field welding. ‘Field welding’ is the welding that is performed at the construction site, as compared to ‘shop welding’ which is the welding that is performed in the factory. Companies that purchase ACCs, as well as the companies that erect them for purchasers, face very high costs to install them, and one of the contributory factors to the high installation cost is the amount of labor, man hours, and equipment costs it takes to do the field welding. Field welding can be very expensive when compared to the cost of shop welding.

The present invention relates to a change in the design of an ACC which will result in substantially less field welding. This will make ACCs cheaper to erect and much more attractive to purchase.

According to a first embodiment of the invention, an angle (L-shaped length of steel) may be shop-welded to the tube sheet on half of the primary HECs. According to this embodiment, the other half of the primary HECs may have a traditional configuration. Both the traditional HECs and the HECs having the shop-welded angle would be shipped to the assembly/field location. According to a preferred embodiment, the angle will be the full length of the inlet HEC tube sheet. At the assembly/field location, the HEC with the shop welded angle would be erected onto the structure first, and then the traditional HEC (the one with no angle welded to the tube sheet) would be erected second. The tube sheet of the second HEC would sit on, and be field welded to, the angle of the first HEC, reducing the current amount of field welding necessary to join the heat exchange coils by 50%.

Approximately 15% to 20% of the coils of a typical A-Frame ACC are so-called “secondary coils,” which often have modified shapes or arrangements to allow for vacuum piping and other infrastructure. The connection between secondary coils according to the invention may or may not be made according to the embodiments described herein, depending on the particular structure/arrangement of the secondary coils.

According to another embodiment, similar to the embodiment above, an inverted V-shaped length of steel, instead of an L-shaped length of steel, is shop welded to the tube sheet on half of the primary HECs. According to this embodiment of the invention, the other one-half of the primary HECs have a standard configuration. Also, according to this embodiment, after the HECs are delivered to the assembly site, the modified HECs are paired with traditional HECs and the tube sheet of the traditional HEC is welded to the inverted V-shaped length of steel that was shop welded to the modified HEC.

According to another embodiment, an inverted U-shaped length of steel is shop welded to the tube sheet on half of the primary HECs. According to this embodiment of the invention, the other one-half of the primary HECs have a standard configuration. Also according to this embodiment, after the HECs are delivered to the assembly site, the modified HECs are paired with traditional HECs and the tube sheet of the traditional HEC is welded to the inverted U-shaped length of steel that was shop welded to the modified HEC.

According to yet another embodiment of the invention, a flat or substantially flat length of steel is shop welded to the tube sheet on half of the primary HECs, and, after delivery of the HECs to the assembly site, the primary HECs to which the flat length of steel has been shop welded are paired with primary HECs having a traditional tube sheet configuration, and the tube sheet of the HEC having a traditional configuration is field welded to the flat plate on the modified HEC. According to a preferred aspect of this embodiment, the edge of the tube sheet that is shop welded to the flat plate is formed with a beveled or angled edge corresponding to the desired angle at which the plate is fitted/shop welded to the tube sheet.

According to another embodiment of the invention, an improved ACC includes an optimized three-dimensional tube sheet shape, which requires no shop-welding of a joining angle or other piece to one of the tube sheets, and which still reduces the current amount of field welding necessary to join the heat exchange coils by up to 50%. According to this embodiment of the invention, the tube sheet shapes may be modified and optimized to allow flexibility of adjusting the elevation of the heat exchange cores, while keeping a zero welding gap, and without changing the design angle of the heat exchange cores.

Instead of two longitudinal field welds to join the component HECs of an A-frame ACC, the present invention eliminates one of these and reduces it to a single longitudinal field weld, resulting in a savings of 50% in this type of field weld, and a total savings of around 10-15% of field welding on the whole ACC.

According to one aspect of the present invention, the two field welds that are made to join the SDM skirts to the tube sheets remain, and are the same size (10 mm) as before.

According to an embodiment of the invention, a 50% reduction in field welding can be achieved where the two HECs meet. According to this embodiment, there are no longer two longitudinal 15 mm welds between a closure plate and each of the HECs as there is according to prior designs. According to preferred embodiments of the present invention, only one field weld need be made at the assembly site in order to join the two HECs. According to a further embodiment of the invention, there is presented a way to achieve a cheaper installed cost at-site.

According to another embodiment of the invention, the need for a closure plate is eliminated. According to this embodiment, less steel, and fewer parts are required to be delivered to the site, and unloaded and handled at the site. Moreover, according to this embodiment, there will be no need to fit up the closure plates to the HECs at the site. According to this embodiment, there is further savings due to reduced material, shipping, and handling/labor costs.

According to the present invention, there is provided ample opportunity for adjustment at the assembly site, as the HEC having the traditional configuration can sit anywhere on the angle/bent shape/tube sheet extension of the modified HEC, and the erector can still easily make a fit up and field weld.

According to the present invention, significant cost savings are presented at the assembly site, and while some work transferred to the manufacturing facility/factory/shop, factory labor is much less costly than assembly labor, and will not add significantly to the cost of fabricating an HEC.

### DESCRIPTION OF THE DRAWINGS

The subsequent description of the preferred embodiments of the present invention refers to the attached drawings, wherein:

FIG. 1 is a perspective view of an air cooled condenser having a generally standard arrangement.

FIG. 2 is a perspective view of the heat exchanger A-frame portion of a prior art air cooled condenser in which the tube sheets of the heat exchanger coils are connected by a closure plate.

FIG. 3 is an end view schematic of a prior art heat exchanger A-frame portion of a prior art air cooled condenser of the type shown in FIG. 2, including exploded views of the connections between the closure plate and the heat exchanger tube sheets and between the steam distribution manifold skirt and the tube sheet.

FIG. 4 is an end view computer model rendering of the heat exchanger A-frame portion of a prior art air cooled condenser shown in FIG. 3.

FIG. 5 is an underside view computer model rendering of the heat exchanger A-frame portion of a prior art air cooled condenser shown in FIG. 3.

FIG. 6A is an end view of an embodiment of the invention in which an angle is show welded to the tube sheet of one heat exchanger and in which the ACC A-frame is site assembled, in part, by field welding the tube sheet of a second, standard configuration, heat exchanger is field welded to the angle of the first heat exchanger.

FIG. 6B is an exploded end view of the embodiment shown in FIG. 6A, but also including the SDM skirts which are preferably field welded to the heat exchanger tube sheets.

FIG. 6C is a perspective view of the embodiment of the invention shown in FIG. 6A.

FIG. 6D is an underside perspective view of the embodiment of the invention shown in FIG. 6A.

FIG. 7 is an end view computer model rendering of the embodiment of the invention shown in FIG. 6B.

FIG. 8 is an underside view computer model rendering of the embodiment of the invention shown in FIG. 6B.

FIG. 9A is an end view of an embodiment of the invention in which the tube sheet of one heat exchanger coil is extended and bent, and in which during site assembly of the ACC A-frame, the tube sheet of a second, standard configuration, heat exchanger is field welded to the extended and bent tube sheet of the first heat exchanger coil.

FIG. 9B is a perspective view of the embodiment of the invention shown in FIG. 9A.

FIG. 9C is an underside perspective view of the embodiment of the invention shown in FIG. 9A.

FIG. 10A is an end view of an embodiment of the invention in which an inverted V-shaped length of steel is shown welded to the tube sheet of one heat exchanger and in during site assembly of the ACC A-frame, the tube sheet of a second, standard configuration, heat exchanger is field welded to the inverted V-shaped length of steel that was shop welded to the first heat exchanger.

FIG. 10B is a perspective view of the embodiment of the invention shown in FIG. 10A.

FIG. 10C is an underside perspective view of the embodiment of the invention shown in FIG. 10A.

FIG. 11A is an end view of an embodiment of the invention in which an inverted U-shaped length of steel is shown welded to the tube sheet of one heat exchanger and in during site assembly of the ACC A-frame, the tube sheet of a second, standard configuration, heat exchanger is field welded to the inverted U-shaped length of steel that was shop welded to the first heat exchanger.

FIG. 11B is a perspective view of the embodiment of the invention shown in FIG. 11A.

FIG. 11C is an underside perspective view of the embodiment of the invention shown in FIG. 11A.

FIG. 12A is an end view of an embodiment of the invention in which a flat length of steel is shown shop welded to an angled or beveled edge of the tube sheet of one heat exchanger and in which, during site assembly of the ACC A-frame, the tube sheet of a second, standard configuration, heat exchanger is field welded to the flat length of steel that was shop welded to the first heat exchanger.

FIG. 12B is a perspective view of the embodiment of the invention shown in FIG. 12A.

FIG. 12C is an underside perspective view of the embodiment of the invention shown in FIG. 12A.

### DETAILED DESCRIPTION OF THE INVENTION

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

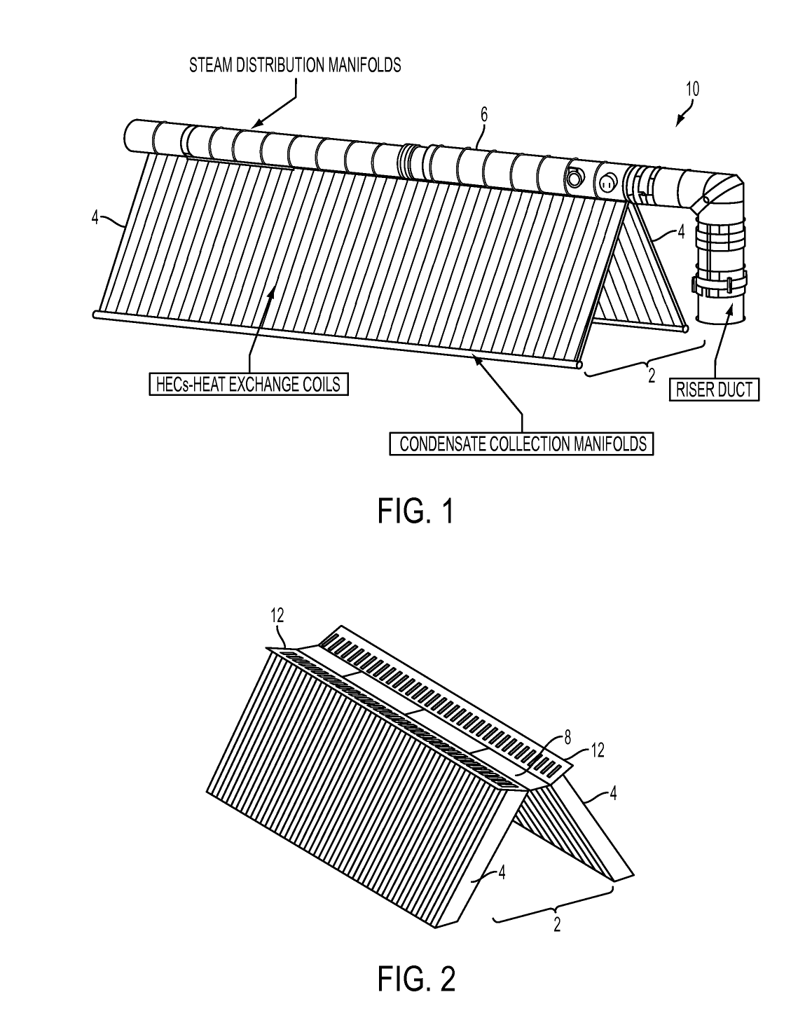

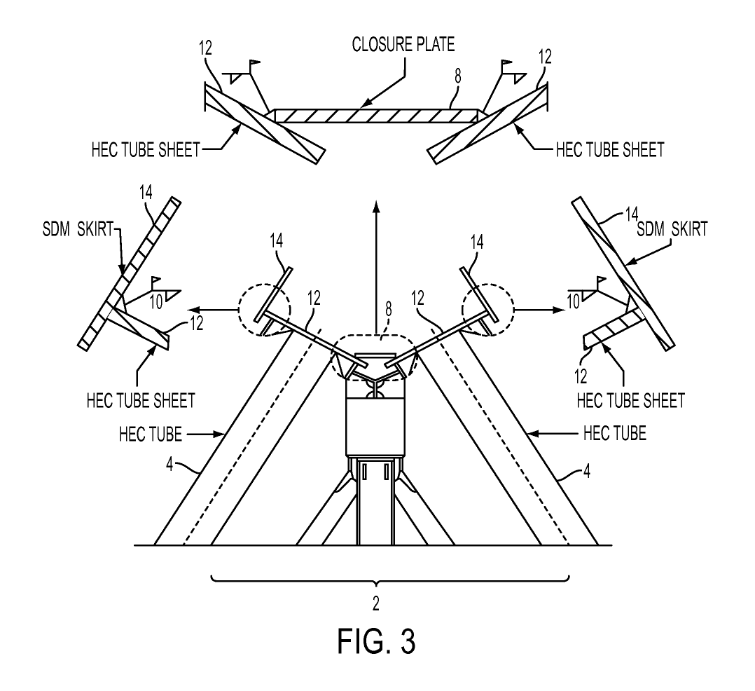

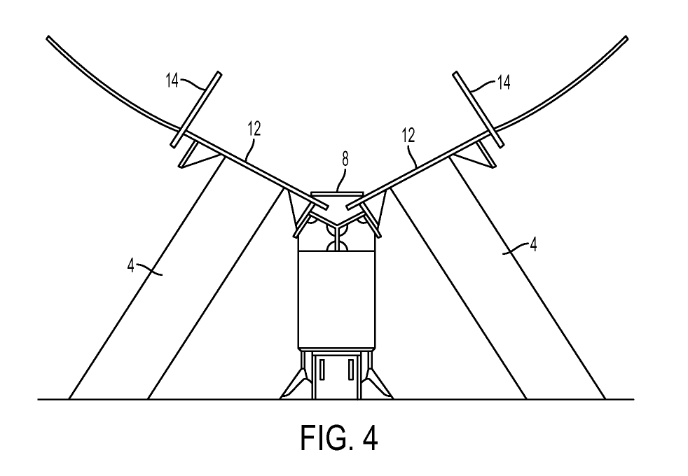

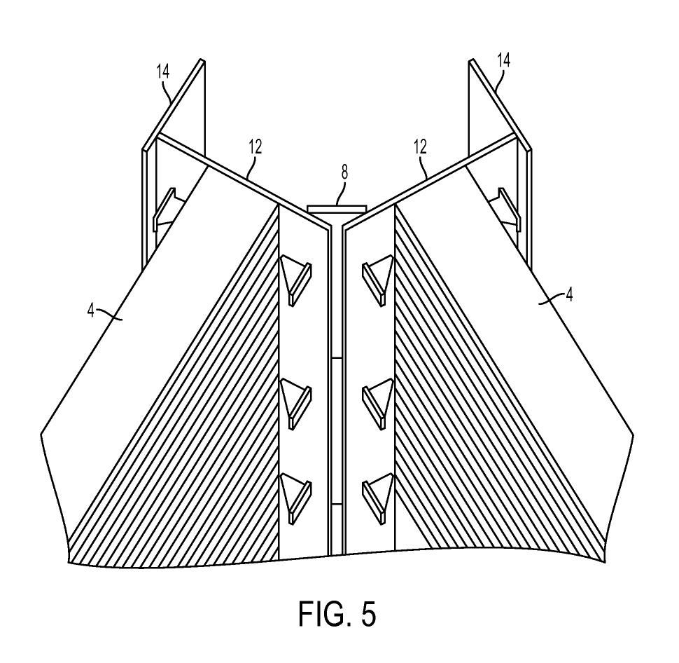

FIG. 1, which is a perspective view of an air cooled condenser having a generally standard arrangement, will first be described to provide context for the present invention. Modern air cooled condensers (ACCs) 10 are generally field assembled in an A-frame arrangement 2 of heat exchanger coils 4, topped by a steam distribution manifold 6. Steam generated by a power plant or other industrial facility passes through a riser duct and into a steam distribution manifold 6. From the steam distribution manifold 6, the steam passes into the heat exchanger coils 4 via the heat exchanger tube sheets 12. As the steam travels down the heat exchanger coils, it cools, and the resulting condensate is collected in the condensate collection manifolds at the bottom of heat exchanger coils 4. According to current and standard manufacturing and assembly procedures, two identical or nearly identical heat exchanger coils 4, including tube sheets 12, are raised into nearly their final position at the final assembly location, and closure plate(s) 8 is/are field welded to the tube sheets 12 of both heat exchanger coils 4. See FIGS. 2-5. SDM skirts 14 are field welded to the opposite sides of the tube sheets 12. According to this process, both sides of the closure plate is field welded the entire length, or nearly the entire length of the ACC, also referred to as “the street.”

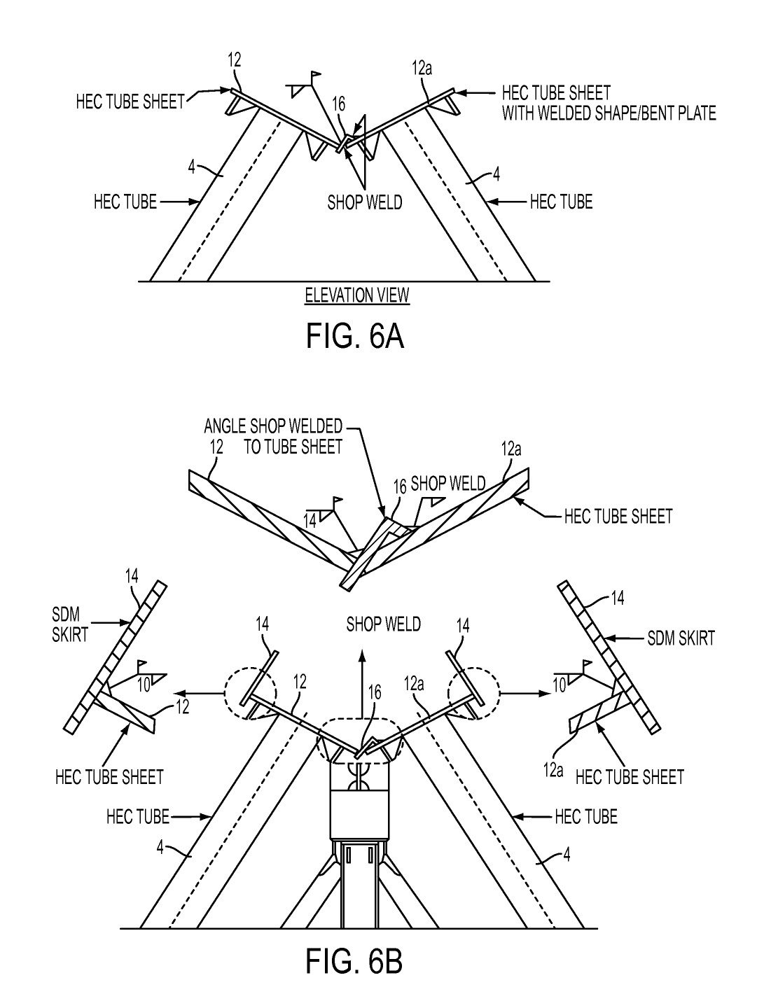

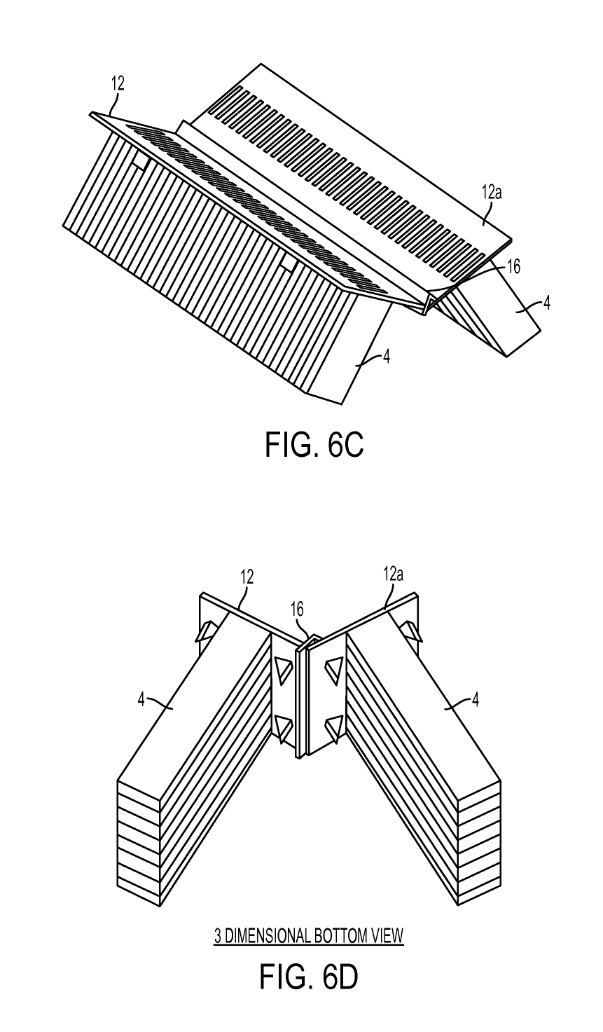

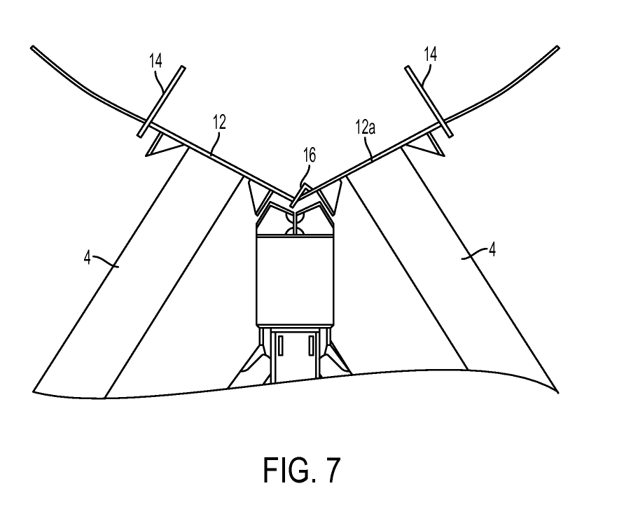

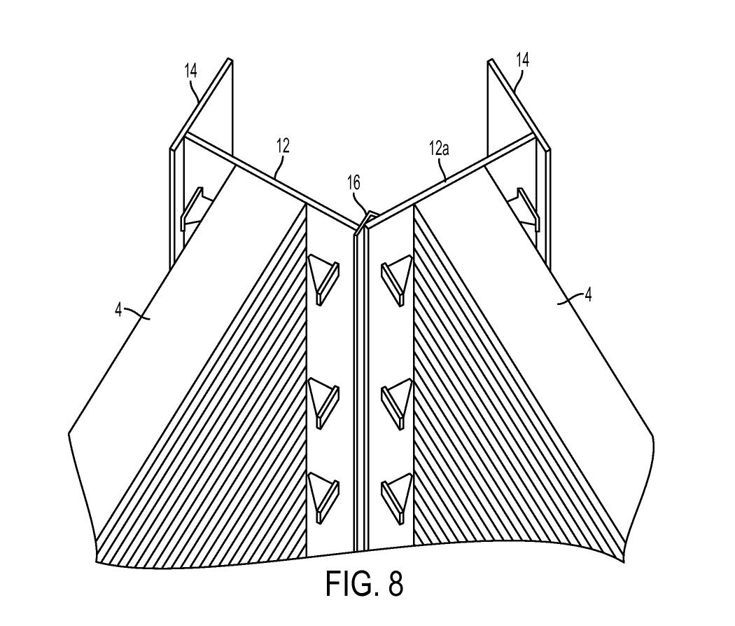

FIGS. 6A through 6D, 7 and 8 show a first embodiment of the invention in which the closure plate 8 is replaced with an angle 16, that is, an L-shaped piece of steel. During the factory manufacture process, angle 16 is shop welded to the tube sheets 12a of one half of the heat exchange coils. According to a preferred embodiment, the end of tube sheets 12a may be angled or beveled to fit flush or nearly flush against a face of the angle 16. The preferred locations of the shop welds are shown in FIGS. 6A and 6B.

For assembly of an ACC according to this first embodiment of the invention, one half of the primary heat exchanger coils that are shipped to the assembly location include the shop welded angle, and the other one half of the primary heat exchanger coils have a generally standard configuration. During assembly of the heat exchanger A-frame 2 at the assembly location, one modified heat exchanger coil bearing the shop welded angle is positioned opposite a generally standard configuration heat exchanger coil, and the inner edge of the tube sheet 12 of the standard configuration heat exchanger coil is field welded to the face of the angle 16 that is opposite the face that is welded to tube sheet 12a of the modified heat exchanger coil.

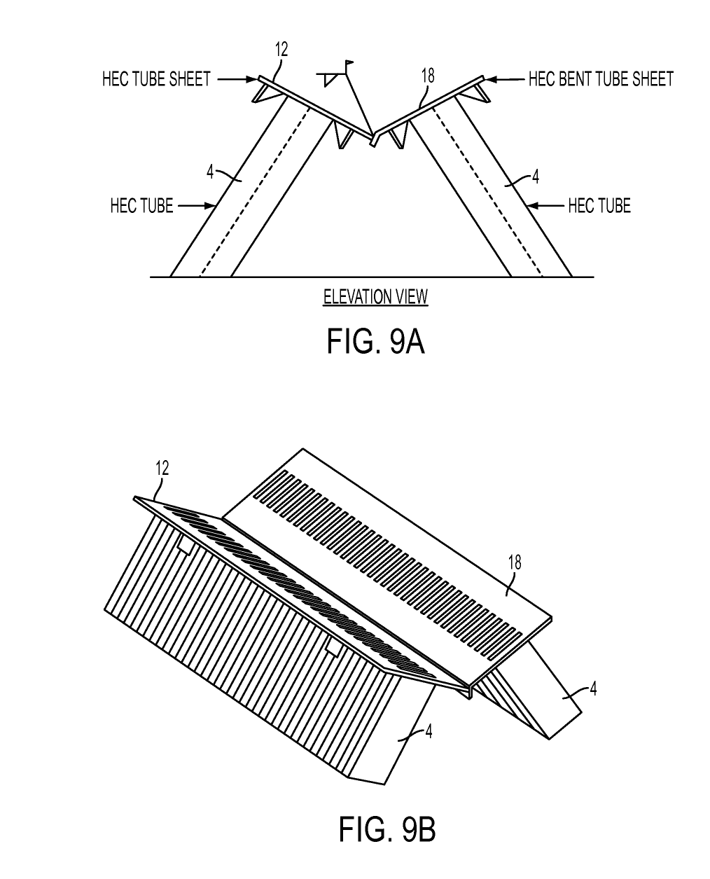

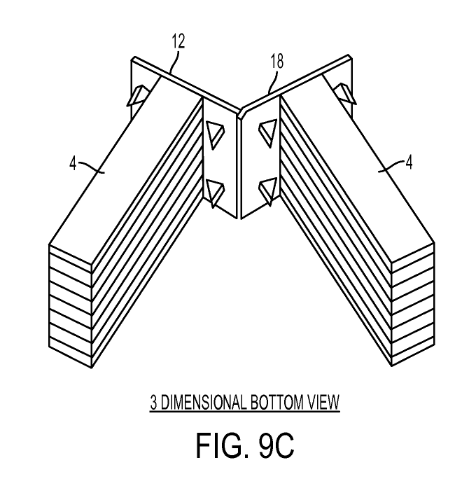

FIGS. 9A through 9C show a second embodiment of the invention in which one half of the primary heat exchanger coils are fitted with an extended and bent tube sheet 18, and the other half of the primary heat exchanger coils may have the standard configuration. The length of the extension and angle of the bend is configured to generally allow for a flush connection between the top face of the bend and the edge of the tube sheet of the heat exchanger coil to which it will be welded during site assembly.

For assembly of an ACC according to this embodiment of the invention, one half of the primary heat exchanger coils that are shipped to the assembly location include the extended and bent tube sheet, and the other one half of the primary heat exchanger coils have a generally standard configuration. During assembly of the heat exchanger A-frame 2 at the assembly location, one modified heat exchanger coil bearing the extended and bent tube sheet 18 is positioned opposite a generally standard configuration heat exchanger coil, and the inner edge of the tube sheet 12 of the standard configuration heat exchanger coil is field welded to the top face of the extended and bent portion of tube sheet 18.

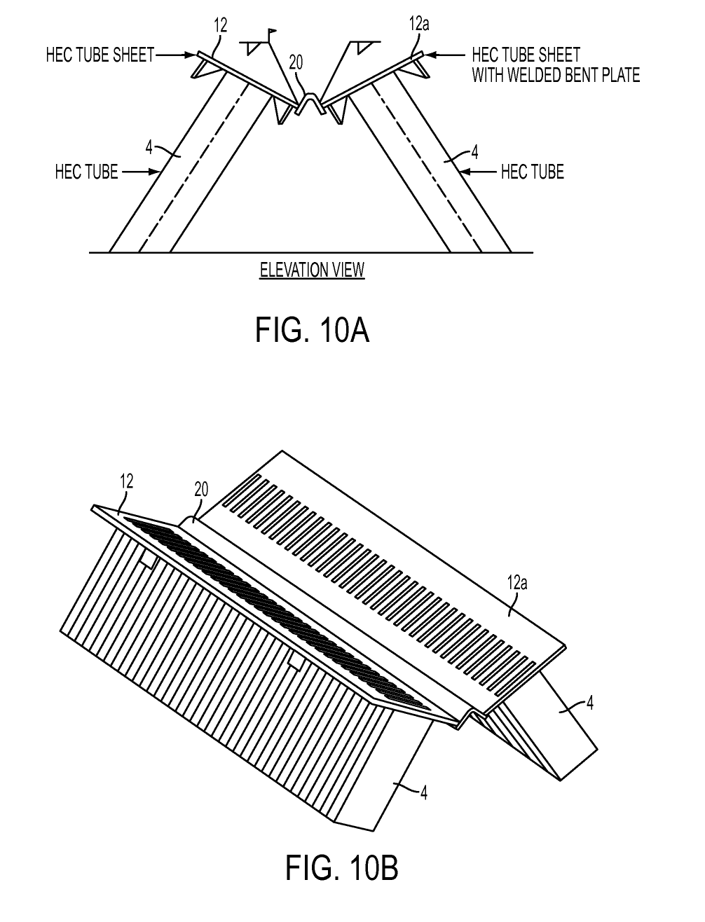

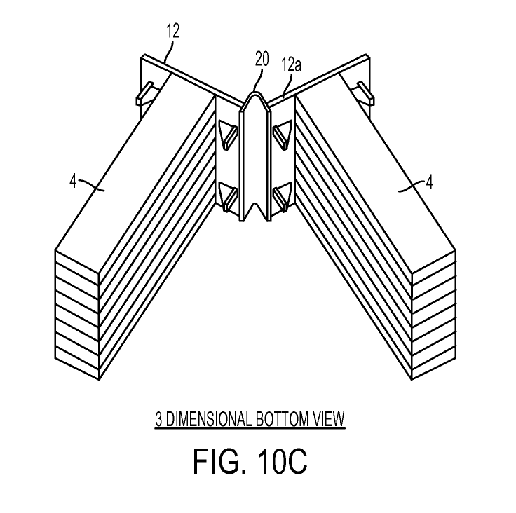

FIGS. 10A through 10C show a third embodiment of the invention in which the closure plate 8 is replaced with an inverted V-shaped length of steel 20 that is shop welded at the factory to the tube sheets 12a of one half of the primary heat exchange coils. According to a preferred embodiment, the end of tube sheets 12a need not be angled or beveled to fit flush or nearly flush against a face of the V-shaped length of steel 20.

For assembly of an ACC according to this third embodiment of the invention, one half of the primary heat exchanger coils that are shipped to the assembly location include the shop welded inverted V-shaped length of steel 20, and the other one half of the primary heat exchanger coils have a generally standard configuration. During assembly of the heat exchanger A-frame 2 at the assembly location, one modified heat exchanger coil bearing the shop welded V-shaped length of steel 20 is positioned opposite a generally standard configuration heat exchanger coil, and the inner edge of the tube sheet 12 of the standard configuration heat exchanger coil is field welded to the face of the V-shaped length of steel 20 that is opposite the face that is welded to tube sheet 12a of the modified heat exchanger coil.

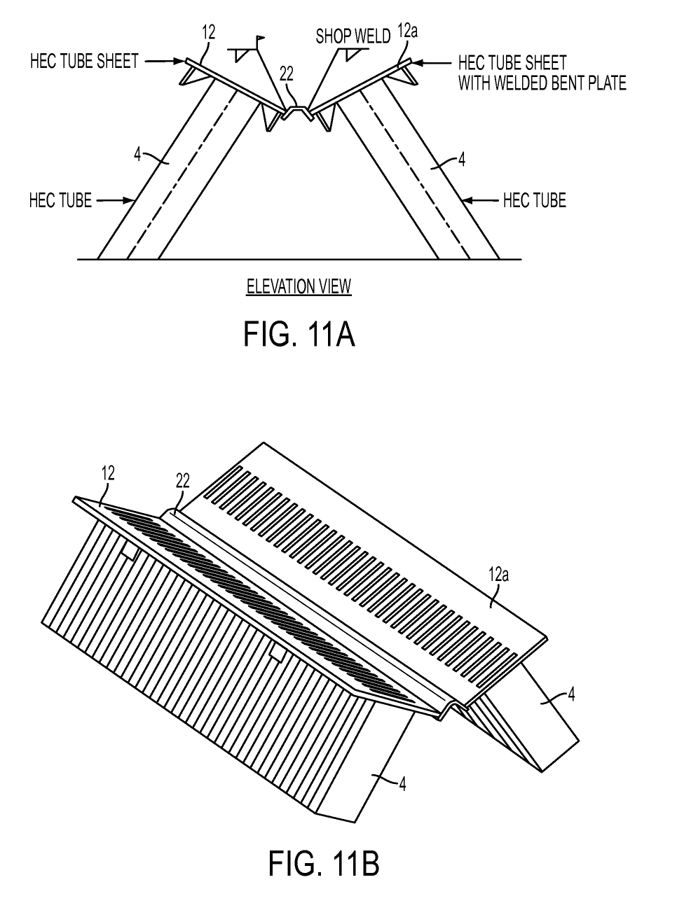

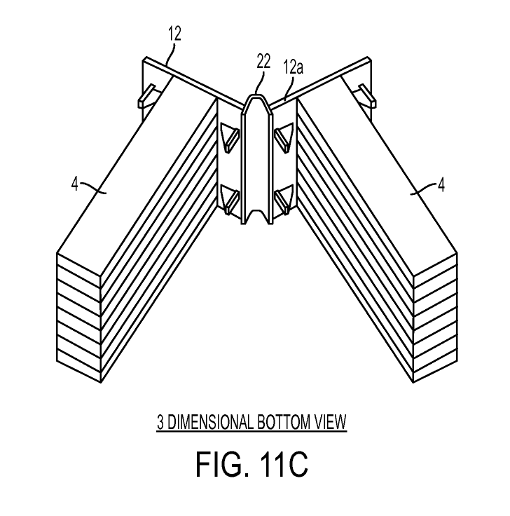

FIGS. 11A through 11C show a fourth embodiment of the invention in which the closure plate 8 is replaced with an inverted U-shaped length of steel 22 that is shop welded at the factory to the tube sheets 12a of one half of the heat exchange coils. According to a preferred embodiment, the end of tube sheets 12a need not be angled or beveled to fit flush or nearly flush against a face of the U-shaped length of steel 22.

For assembly of an ACC according to this fourth embodiment of the invention, one half of the primary heat exchanger coils that are shipped to the assembly location include the shop welded inverted U-shaped length of steel 22, and the other one half of the primary heat exchanger coils have a generally standard configuration. During assembly of the heat exchanger A-frame 2 at the assembly location, one modified heat exchanger coil bearing the shop welded U-shaped length of steel 22 is positioned opposite a generally standard configuration heat exchanger coil, and the inner edge of the tube sheet 12 of the standard configuration heat exchanger coil is field welded to the face of the U-shaped length of steel 22 that is opposite the face that is welded to tube sheet 12a of the modified heat exchanger coil.

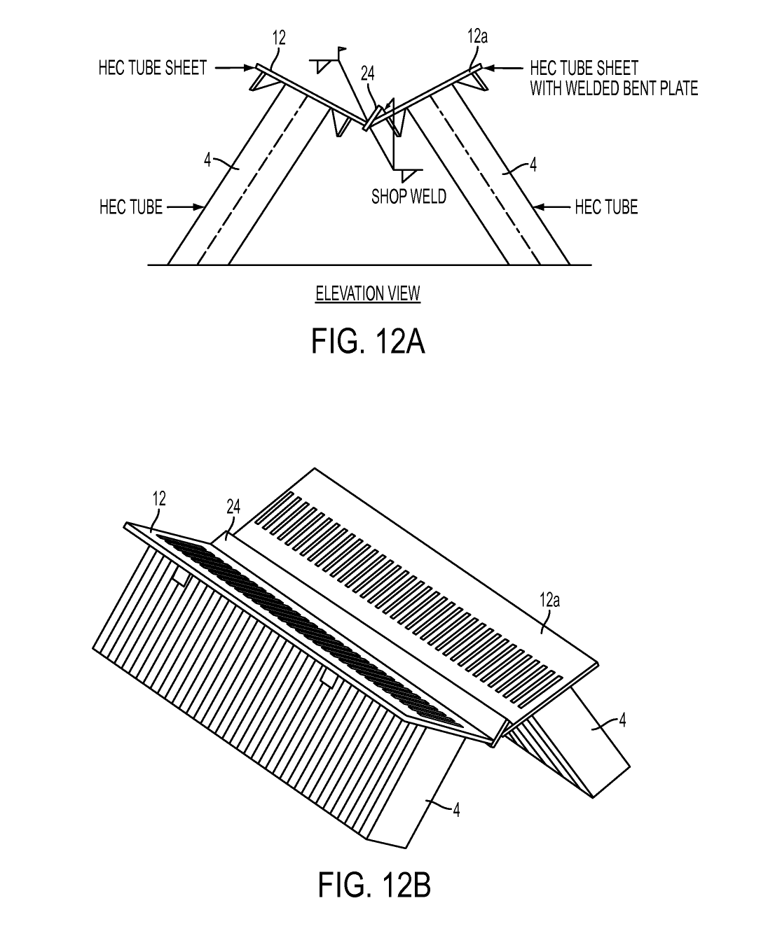

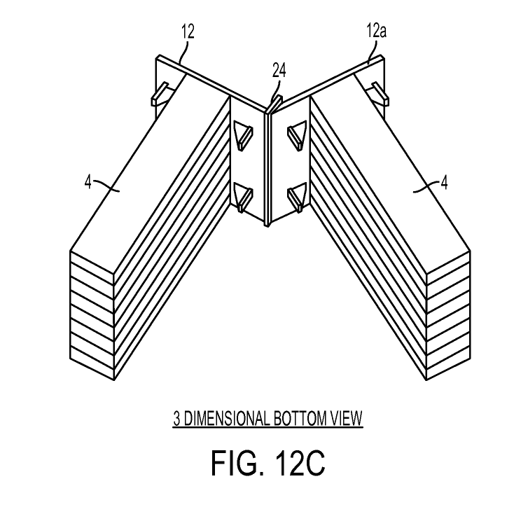

FIGS. 12A through 12C show a fifth embodiment of the invention in which the closure plate 8 is replaced with a flat length of steel 24 that is shop welded at the factory to the tube sheets 12a of one half of the primary heat exchanger coils. According to a preferred embodiment, the end of tube sheets 12a may be angled or beveled to fit flush or nearly flush against a face of the flat length of steel 24. The angle at which the flat length of steel 24 is welded to the end of tube sheet 12a may be configured to generally allow for a flush connection between the face of the flat length of steel that is opposite the shop weld and the edge and the edge of the tube sheet 12 of the heat exchanger coil to which it will be welded during site assembly.

For assembly of an ACC according to this fifth embodiment of the invention, one half of the primary heat exchanger coils that are shipped to the assembly location include the shop welded flat length of steel 24, and the other one half of the primary heat exchanger coils have a generally standard configuration. During assembly of the heat exchanger A-frame 2 at the assembly location, one modified heat exchanger coil bearing the shop welded flat length of steel 24 is positioned opposite a generally standard configuration heat exchanger coil, and the inner edge of the tube sheet 12 of the standard configuration heat exchanger coil is field welded to the face of the flat length of steel 24 that is opposite the face that is welded to tube sheet 12a of the modified heat exchanger coil.

It will be appreciated that other manufacturing (shop) modifications to one half of the heat exchange coils of an ACC which permit easy field fit and reduce field welding during assembly are within the scope of this invention and well within the skill of ordinary practitioners, given the disclosure of the invention herein.

1. An air cooled condenser comprising:
a steam distribution manifold;
at least two heat exchanger coils arranged in an A-frame configuration in fluid communication with said steam distribution manifold,
each of said heat exchanger coils fitted with a tube sheet,
wherein the tube sheets of less than all of said heat exchanger coils have been modified prior to arrival at the assembly location to be connected to a tube sheet of an opposing heat exchanger coil in said A-frame configuration along a single field welded seam.

2. An air cooled condenser according to claim 1, wherein up to one half of said heat exchanger coils have been modified prior to arrival at the assembly location to be connected to a tube sheet of an opposing heat exchanger coil in said A-frame configuration along a single field welded seam.

3. An air cooled condenser according to claim 2, wherein said opposing heat exchanger coils have a flat and unmodified tube sheet.

4. An air cooled condenser according to claim 1, wherein said modification comprises an extended and bent tube sheet configured to mate with an edge of a tube sheet of an opposing heat exchanger coil in a flush or nearly flush interface.

5. An air cooled condenser according to claim 1, wherein said modification comprises a length of steel that has been shop welded to an edge of said modified tube sheet.

6. An air cooled condenser according to claim 5, wherein said length of steel is flat.

7. An air cooled condenser according to claim 5, wherein said length of steel is L-shaped.

8. An air cooled condenser according to claim 5, wherein said length of steel is an inverted U-shape.

9. An air cooled condenser according to claim 5, wherein said length of steel is an inverted V-shape.

10. A heat exchanger coil for an air cooled condenser, comprising:
a heat exchanger coil fitted with a modified tube sheet, wherein said modification permits the connection of said heat exchanger coil to an opposing heat exchanger coil in an A-frame of an air cooled condenser along a single field welded seam.

11. A heat exchanger coil according to claim 10, wherein said modification comprises an extended and bent tube sheet configured to mate with an edge of a tube sheet of an opposing heat exchanger coil in a flush or nearly flush interface.

12. A heat exchanger coil according to claim 10, wherein said modification comprises a length of steel that has been shop welded to an edge of said modified tube sheet.

13. A heat exchanger coil according to claim 12, wherein said length of steel is flat.

14. A heat exchanger coil according to claim 12, wherein said length of steel is L-shaped.

15. A heat exchanger coil according to claim 12, wherein said length of steel is an inverted U-shape.

16. A heat exchanger coil according to claim 12, wherein said length of steel is an inverted V-shape

17. A method of assembling an air cooled condenser including a steam distribution manifold supported on an A-frame arrangement of heat exchanger coils, comprising:
positioning a first heat exchanger coil in a final or near-final assembly location and orientation; positioning a second heat exchanger coil in a final or near-final assembly location and orientation opposite said first heat exchanger coil,
wherein one of said first and second heat exchanger coils has a factory modified tube sheet configured to permit the connection of said heat exchanger coil to an opposing heat exchanger coil in an A-frame of an air cooled condenser along a single field welded seam;
field welding said first heat exchanger coil to said second heat exchanger coil along a single field welded seam.

18. A method according to claim 17, wherein said modification comprises an extended and bent tube sheet configured to mate with an edge of a tube sheet of an opposing heat exchanger coil in a flush or nearly flush interface.

19. A method according to claim 17, wherein said modification comprises a length of steel that has been shop welded to an edge of said modified tube sheet.

20. A method according to claim 19, wherein said length of steel is flat.

21. A method according to claim 19, wherein said length of steel is L-shaped.

22. A method according to claim 19, wherein said length of steel is an inverted U-shape.

23. A method according to claim 19, wherein said length of steel is an inverted V-shape
